(19) United States
(12) Patent Application Publication
(10) Pub. No.: US 2024/0307255 A1
(43) Pub. Date: Sep. 19, 2024

(54) MASSAGE ROLLER AND MANUFACTURING METHOD THEREOF

(71) Applicant: YUN YANG INDUSTRIAL CO., LTD., Taichung City (TW)

(72) Inventor: SHIH-CHANG CHEN, TAICHUNG CITY (TW)

(21) Appl. No.: 18/121,204

(22) Filed: Mar. 14, 2023

(51) Int. Cl. A61H 15/00

(52) U.S. Cl. CPC A61H 15/0092

(57) ABSTRACT

A manufacturing method of a massage roller includes a first injection processing step, a second injection processing step, and a skin attaching step. In the first injection processing step, a tube member is injected to be formed in a mold. In the second injection processing step, a coating member is injected on the outer periphery of the tube member in the mold, wherein a drop exists between two ends of the coating member and the tube member. The skin attaching step is carried out after the second injection processing step, wherein a skin layer is attached to cover the surface of the coating member, finishing the massage roller. Accordingly, the tube member and coating member are formed through a two-shot injection molding operation, facilitating the attachment of the skin layer to the coating member, and providing an aesthetic appearance which is less distorted.

### BACKGROUND OF THE INVENTION

### 1. Field of the Invention

The present invention relates to rollers, and more particularly, to a massage roller and manufacturing method thereof.

### 2. Description of the Related Art

Moderate massage is able to temporarily stimulate muscles and fascia of human body, achieving the purpose of soothing and relaxing, and promoting the blood circulation. Also, to enhance the effect of massage, a roller is often used as a tool for effectively removing the accumulation of lactic acid after exercise or relieving soreness of human body.

Referring to FIG. 1 and FIG. 2, a conventional massage roller 1 is disclosed, which generally includes a hollow tube part 2 and a massage part 3 surrounding the outer periphery of the tube part 2. The tube part 2 is used in cooperation with a rod member (not shown). The massage part 3 has a plurality of concave grooves and a plurality of protrusion blocks alternately arranged. A leather layer 4 having embossed patterns is attached to the surface of the massage part 3, so as to increase the softness and friction coefficient of the contact between the massage roller 1 and human body.

However, the tube part 2 and the massage part 3 of the massage roller 1 are formed through a one-shot injection-molding, and the materials used are mostly hard materials, such as ABS resin. After the one-shot injection molding process of the tube part 2 and the massage part 3, the leather layer 4 is adhered to the massage part 3. Since there is no drop on the border between two ends of the tube part 2 and the massage part 3, it is difficult for the staff to accurately control the adherence area when attaching the leather layer 4, which easily causes the distortion of the adherence area. As a result, the aesthetic appearance of the product is affected, and the leather layer 4 is also prone to coming off after a long period of usage.

### SUMMARY OF THE INVENTION

To improve the issues above, the present invention discloses a massage roller and manufacturing method thereof. The manufacturing method applies a two-shot injection molding manner, after which the skin layer is attached to the coating member, such that the skin layer is easily attached to the massage roller, thereby preventing the distortion of the adherence effect.

For achieving the aforementioned objectives, a massage roller in accordance with an embodiment of the present invention is provided, comprising a tube member and a coating member. The tube member is formed through a first injection processing and comprises two end parts disposed in opposite to each other. The coating member is formed on an outer periphery of the tube member through a second injection processing and comprises two distal ends tapering toward two end parts. Therein, a lateral side is radially extended between each of the two distal ends and each of the corresponding two end parts, respectively, such that a drop is formed between the two distal ends and the two corresponding end parts, respectively. The coating member comprises a plurality of ribs and a plurality of grooves alternately disposed along the axial direction of the tube member.

In another embodiment, the present invention further comprises a skin layer attached to cover the surface of the coating member, but without covering the two lateral sides, such that an exposed area not covered by the skin layer is formed on the two end parts in adjacent to the two lateral sides, respectively.

For achieving the aforementioned objectives, the present invention provides a manufacturing method of a massage roller, comprising following steps: a first injection processing step, and a second injection processing step. In the first injection processing step, a tube member is injection molded in a mold, and the tube member comprises two end parts disposed in opposite to each other. In the second injection processing step, a coating member is injected on an outer periphery of the tube member in the mold, and the coating member comprises two distal ends tapering toward two end parts. Therein, a lateral side is radially extended between each of the two distal ends and each of the corresponding two end parts, respectively, such that a drop is formed between the two distal ends and the two corresponding end parts, respectively. The coating member comprises a plurality of ribs and a plurality of grooves alternately disposed along the axial direction of the tube member.

In another embodiment, the method further comprises a skin attaching step after the second injection processing step. In the skin attaching step, a skin layer is attached to cover the surface of the coating member, and an exposed area not covered by the skin layer is formed on the two end parts in adjacent to the two lateral sides, respectively.

Accordingly, through the two-shot injection processing manner, the present invention orderly forms the tube member and the coating member covering the tube member, with the drop formed between the distal end of the coating member and the end part of the tube member. Therefore, the staff is allowed to clearly identify the to-be-attached part, so as to accurately attach the skin layer on the surface of the coating member, preventing the distortion of the adherence and ensuring the aesthetic appearance of the roller surface.

### BRIEF DESCRIPTION OF THE DRAWINGS

FIG. 1 is a perspective view of a conventional massage roller.

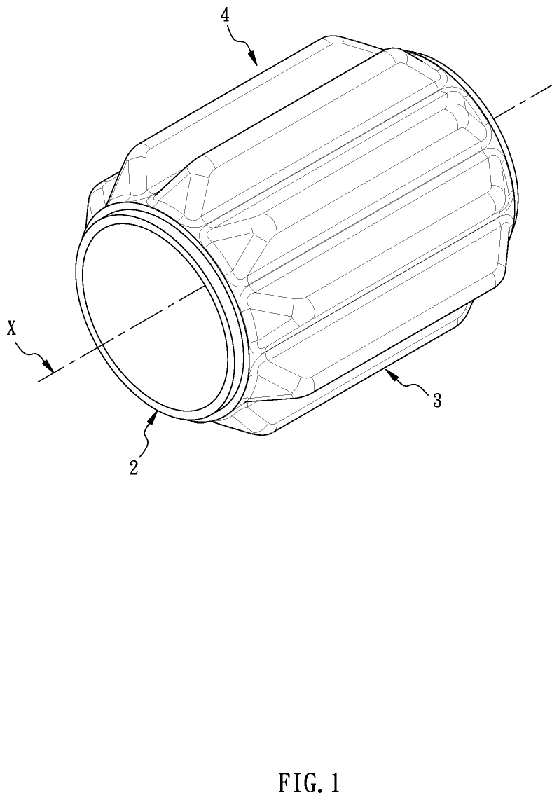

FIG. 2 is a sectional view of the conventional massage roller.

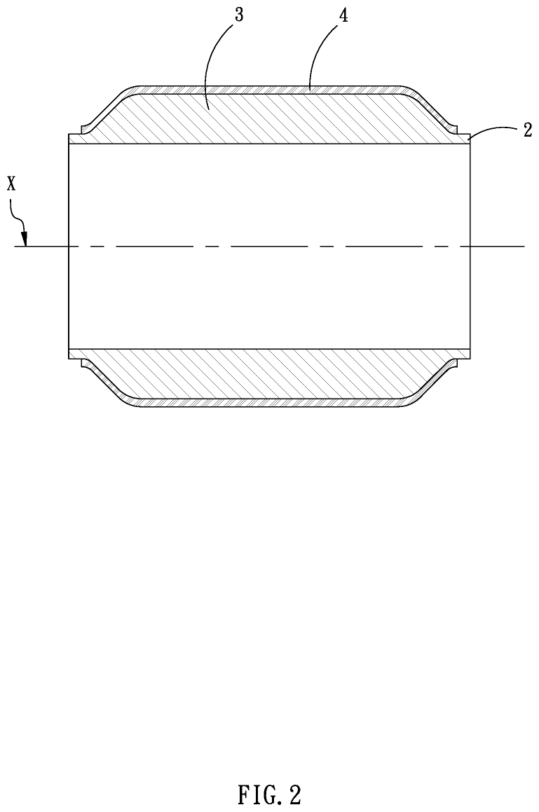

FIG. 3 is a flow chart of the manufacturing method of the massage roller in accordance with an embodiment of the present invention.

FIG. 4 is a perspective view of the massage roller in accordance with an embodiment of the present invention.

FIG. 5 is a sectional view of the massage roller in accordance with an embodiment of the present invention.

### DETAILED DESCRIPTION OF THE INVENTION

The aforementioned and further advantages and features of the present invention will be understood by reference to the description of the preferred embodiment in conjunction with the accompanying drawings. However, the technical features included by the present invention are not limited to certain embodiments hereby provided. Scope of the present invention shall be referred to the claims, which include all the possible replacements, modifications, and equivalent features. In addition, to facilitate the understanding and reading of people having skilled in the art, the structural dimensions and sizes of the components presented are schematically presented in the drawings and not intended to limit the implementation of the present invention.

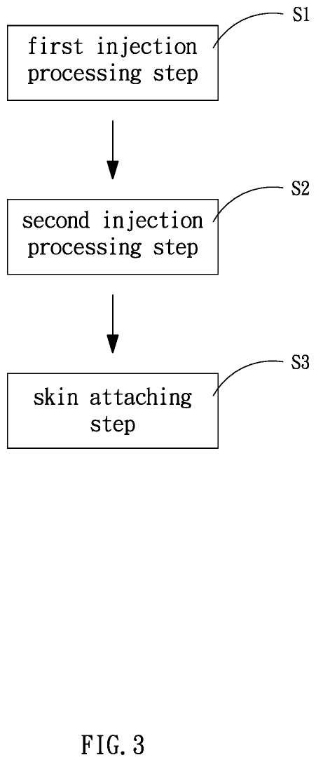

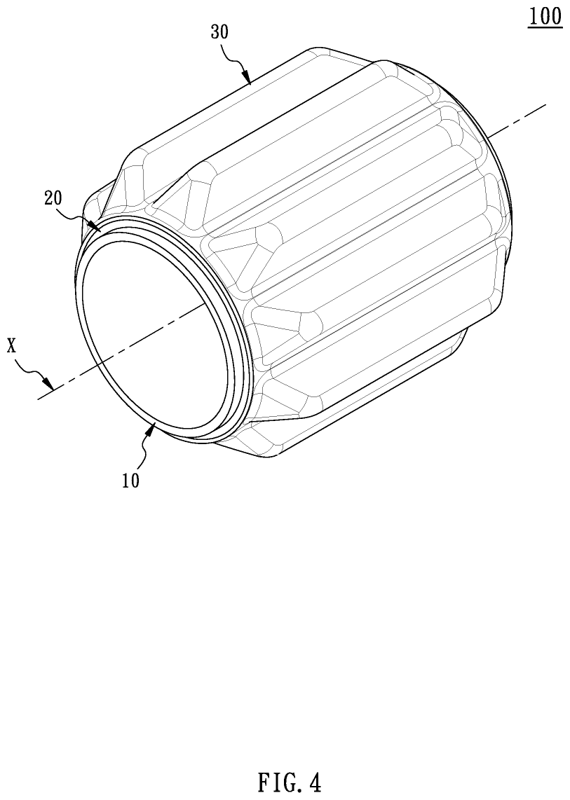

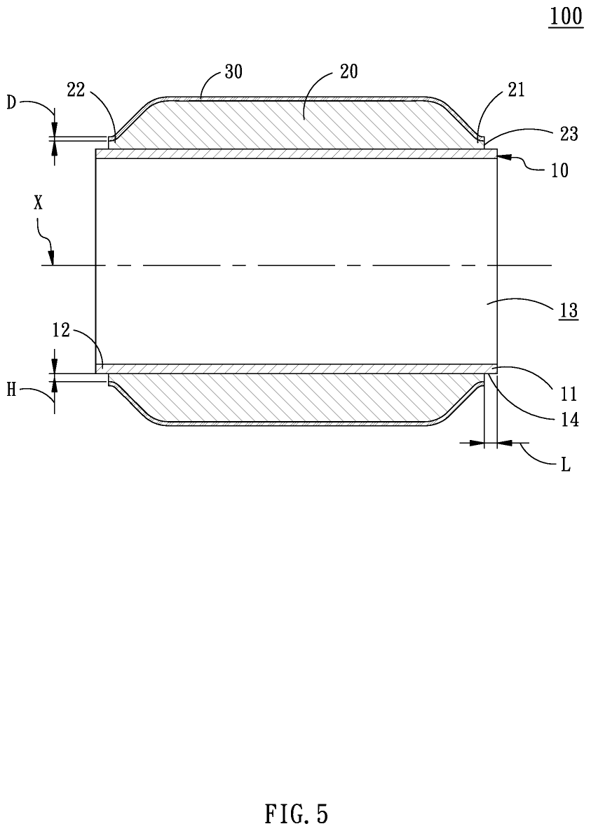

FIG. 3 is a flow chart of a manufacturing method of a massage roller 100 in accordance with an embodiment of the present invention. FIG. 4 is a perspective view of the massage roller 100 in accordance with the embodiment of the present invention. FIG. 5 is a sectional view of the massage roller 100 in accordance with the embodiment of the present invention. Therein, referring to FIG. 3, the manufacturing method of the embodiment is applied to manufacture the massage roller 100 shown by FIG. 4 and FIG. 5. The manufacturing method comprises a first injection processing step S1, a second injection processing step S2, and a skin attaching step S3.

In the first injection processing step S1, a tube member 10 is injection molded in a mold, wherein the tube member 10 comprises two end parts 11, 12 disposed in opposite to each other. Therein, the tube member 10 comprises an axial bore 13 arranged along an axial direction X, such that a massage rod is able to pass through the axial bore 13 to be combined therewith, allowing the user to hold the massage rod for using the massage roller 100 to contact a human body in a rolling manner, thereby achieving a massage effect.

In the second injection processing step S2, a coating member 20 is injection molded on an outer periphery of the tube member 10 in the mold. The coating member 20 comprises two distal ends 21, 22 tapering toward two end parts 11, 12 of the tube member 10, so as to form a structure whose two ends are relatively thinner than the middle part thereof. A lateral side 23 extends along a radial direction between each of the two distal ends 21, 22 and each of the corresponding two end parts 11, 12, respectively, such that a drop is formed between the two distal ends 21, 22 and the two corresponding end parts 11, 12, respectively. The coating member 20 comprises a plurality of ribs and a plurality of grooves disposed along the axial direction X of the tube member 10, wherein the ribs and the grooves are disposed in an alternating arrangement for providing the massage effect to the human body. Therein, the first injection processing step S1 and the second injection processing step S2 are allowed to be carried out through a single or different injection molding machines, and a hardness of the tube member 10 is larger than a hardness of the coating member 20.

The skin attaching step S3 is carried out after the second injection processing step S2. In the skin attaching step S3, a skin layer 30 is attached to cover a surface of the coating member 20 but without covering the two lateral sides 23. Therein, the surface of the skin layer 30 is allowed to be provided with anti-slip embossed patterns or lines. In the embodiment, each of the two end parts 11, 12 comprises an exposed area 14 arranged in adjacent to the two lateral sides 23 and not covered by the skin layer 30. A length L of the exposed area 14 is larger than a height H of each lateral side 23. Also, the height H of each lateral side 23 is larger than a thickness D of the skin layer 30.

With the foregoing manufacturing steps, the present invention manufactures the massage roller 100. Also, through the two-shot injection molding process, the present invention orderly forms the tube member 10 and the coating member 20 covering the tube member 10, with the drop formed between the coating member 20 and the tube member 10. Therefore, when the staff is adhering the skin layer 30, the adherence portion is clearly identified, such that the skin layer 30 is accurately adhered to the surface of the coating member 20, preventing the distortion of adherence and ensuring that the skin layer 30 is smoothly attached to the coating member 20. Thus, the aesthetic appearance of the massage roller 100 is improved, and the skin layer 30 is prevented from detachment after a long period of usage.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A massage roller, comprising:
a tube member formed through a first injection processing and comprising two end parts disposed in opposite to each other; and
a coating member formed on an outer periphery of the tube member through a second injection processing, the coating member comprising two distal ends tapering toward the two end parts, a lateral side extending along a radial direction between each of the two distal ends and each of the two end parts, respectively, a drop being formed between the two distal ends and the two end parts, the coating member comprising a plurality of ribs and a plurality of grooves disposed in an alternate arrangement along an axial direction of the tube member.

2. The massage roller of claim 1, further comprising a skin layer, the skin layer being attached to cover a surface of the coating member but without covering the two lateral sides, and an exposed area not covered by the skin layer being formed on the two end parts and arranged in adjacent to the two lateral sides, respectively.

3. The massage roller of claim 2, wherein a length of the exposed area is larger than a height of each of the lateral sides.

4. The massage roller of claim 3, wherein the height of each of the lateral sides is larger than a thickness of the skin layer.

5. The massage roller of claim 4, wherein a hardness of the tube member is larger than a hardness of the coating member.

6. A manufacturing method of a massage roller, comprising following steps:
a first injection processing step injection molding a tube member in a mold, the tube member comprising two end parts disposed in opposite to each other; and
a second injection processing step injection molding a coating member on an outer periphery of the tube member in the mold, the coating member comprising two distal ends tapering toward the two end parts, a lateral side extending along a radial direction between each of the two distal ends and each of the two end parts, respectively, a drop being formed between the two distal ends and the two end parts, the coating member comprising a plurality of ribs and a plurality of grooves disposed in an alternate arrangement along an axial direction of the tube member.

7. The manufacturing method of claim 6, further comprising a skin attaching step after the second injection processing step; in the skin attaching step, a skin layer being attached to cover a surface of the coating member, and an exposed area not covered by the skin layer being formed on the two end parts and arranged in adjacent to the two lateral sides, respectively .

8. The manufacturing method of claim 7, wherein a length of the exposed area is larger than a height of each of the lateral sides.

9. The manufacturing method of claim 8, wherein the height of each of the lateral sides is larger than a thickness of the skin layer.

10. The manufacturing method of claim 9. wherein a hardness of the tube member is larger than a hardness of the coating member.
